(19) United States
(12) Patent Application Publication
(10) Pub. No.: US 2007/0192375 A1
(43) Pub. Date: Aug. 16, 2007

(54) Method and computer system for updating data when reference load is balanced by mirroring

(76) Inventors: Yoji Nakatani, Yokohama (JP); Takaki Nakamura, Ebina (JP); Yohsuke Ishii, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/399,506

(22) Filed: Apr. 7, 2006

(30) Foreign Application Priority Data
Feb. 15, 2006 (JP) 2006-037639

(51) Int. Cl. G06F 17/30

(52) U.S. Cl. 707/200

(57) ABSTRACT

Provided is a method of updating a mirror in a storage system that has a plurality of servers in which a mirror is created as a replica of a file system and the access load is balanced among a plurality of servers each having the mirror. Upon reception of an access request from a client computer, it is judged whether or not the client has a possibility of issuing at least one of update requests. In a case where it is judged that the client has a possibility of issuing at least one of update requests, a master from which a mirror is copied is selected. In a case where it is judged that the client does not have a possibility of issuing at least one of update requests, a mirror is selected. Then, access to the selected master or mirror is executed as requested.

### CLAIM OF PRIORITY

The present application claims priority from Japanese application JP2006-037639 filed on Feb. 15, 2006, the content of which is hereby incorporated by reference into this application.

### BACKGROUND

The technology disclosed in this specification relates to a technique of balancing a load among a plurality of servers in file servers or network attached storages (NAS) that are connected to clients via a network to store data used by the clients.

Network attached storage (NAS) has been proposed in which computers connected to a network use a storage system connected to the network as a shared disk. NAS is composed of a server which contains a network interface and others, and a disk drive for storing data.

To give an example, U.S. Pat. No. 6,671,773 discloses clustered NAS in which each of a plurality of servers is connected to a network. In a system described in U.S. Pat. No. 6,671,773, a network element, a switching element, and a disk element correspond to NAS servers. The system described in U.S. Pat. No. 6,671,773 has a plurality of network elements, which can share a file system. The system also has a plurality of disk elements so that data is migrated on a disk basis. Each network element can access every file system owned by the disk elements. Migration of a disk storing a file system among the disk elements does not affect access from a network element to a file system, and each network element can access every file system during the migration.

A network file system (NFS) has been proposed as one of file systems that allow access to files scattered over a network. According to NFS v4 (RFC3530), which is the latest NFS at present (see an online article “RFC3530, NFS version 4”, pp. 58-61, IETF Home Page, searched Jan. 10, 2006, the Internet <URL: http://www.ietf.org/home.html>), when a file system is migrated among servers, each of the servers notifies location information of the migration destination in response to a request made by a client to access the file system. The client uses the notified location information to access the file system at the migration destination. Furthermore, a replication function implemented through a procedure similar to that of the migration enables a client to obtain a list of servers that have replicas (mirrors) of a file system.

### SUMMARY

In clustered NAS which has a plurality of servers, a mirror of a file system, or a mirror of a part of a file system, is created, and different mirrors are managed by different servers. Requests made by clients to access a file system or a part of the file system are allocated among servers for managing mirrors, by a replication function or the like. As a result, access from the clients is distributed among a plurality of servers. However, since the requests from the clients are allocated to the mirrors, data has to be consistent among all the mirrors. This limits the use of load balancing by mirroring to reference only, and no prior art has disclosed a method of updating data in such mirrors.

A computer system according to a representative aspect of this invention, includes: one or more client computers; and a storage system coupled to the client computers via a network, and is characterized in that: the storage system has a plurality of servers including a first server and a second server, and one or more disk subsystems coupled to the plurality of servers; the disk subsystems each have one or more logical devices to store data written by the client computers; each server has an interface coupled to the network, a processor coupled to the interface, and a memory coupled to the processor; the first server manages, as one or more file systems, data stored in the logical devices; the second server manages a second directory tree, which is a replica of a first directory tree corresponding to an entirety or a part of one file system that is managed by the first server; the processor receives, from one of the client computers, via the interface, a request to access a file belonging to the first directory tree or the second directory tree, and judges whether the client computer that has issued the access request has a possibility of issuing at least one of update requests or not; the processor selects the first directory tree, when judging that the client computer has a possibility of issuing at least one of update requests; the processor selects the second directory tree, when judging that the client computer does not have a possibility of issuing at least one of update requests; and in a case where the selected directory tree is managed by a server to which the processor that has made the selection belongs, the processor executes access to the selected directory tree as requested.

According to an embodiment of this invention, it is possible for the storage system having the plurality of servers, in which a reference load can be balanced among the plurality of servers by creating a mirror of an entire file system or a mirror of a directory tree, which is a part of the file system. In addition, what type of access is being made from a client is determined, and an access containing an update request is allocated only to masters, to thereby update a directory tree having a plurality of mirrors without needing to take such measures as keeping the order of update among a plurality of servers and implementing lock control. Moreover, an update made to the master is reflected on its mirror, thereby making it possible for a client to refer to the updated data by referring to the mirror.

### BRIEF DESCRIPTION OF THE DRAWINGS

FIG. 1 is a block diagram showing a configuration of a computer system according to an embodiment of this invention.

FIG. 2 is an explanatory diagram of a configuration of server software according to the embodiment of this invention.

FIG. 3 is an explanatory diagram of a global name space provided to a client according to the embodiment of this invention.

FIG. 4 is an explanatory diagram of a mount point control table according to the embodiment of this invention.

FIG. 5 is an explanatory diagram of a directory tree management table according to the embodiment of this invention.

FIG. 6 is an explanatory diagram of a mirror management table according to the embodiment of this invention.

FIG. 7 is an explanatory diagram of a file system management table according to the embodiment of this invention.

FIG. 8 is an explanatory diagram showing mirror relations in the embodiment of this invention.

FIG. 9 is a flow chart for mirror creating processing which is executed by a mirror control module according to the embodiment of this invention.

FIG. 10 is a flow chart for processing that is executed by a file system processing module to allocate access requests according to the embodiment of this invention.

FIG. 11 is an explanatory diagram of a directory tree list displaying screen which is displayed on a management screen according to the embodiment of this invention.

FIG. 12 is an explanatory diagram of a mirror creating operation screen which is displayed on the management screen according to the embodiment of this invention.

FIG. 13 is a block diagram showing a configuration of an administrative computer according to the embodiment of this invention.

FIG. 14 is a flow chart for directory tree selecting processing which is executed by the file system processing module according to the embodiment of this invention.

FIG. 15 is an explanatory diagram of a mount parameter table according to the embodiment of this invention.

FIG. 16 is an explanatory diagram of an update client table according to the embodiment of this invention.

FIG. 17 is an explanatory diagram of a name space that is provided to a client when path names are served as a basis to judge whether or not there is an update request according to the embodiment of this invention.

FIG. 18 is an explanatory diagram of mount point control table of when path names are served as a basis to judge whether or not there is an update request according to the embodiment of this invention.

### DETAILED DESCRIPTION OF THE PREFERRED EMBODIMENTS

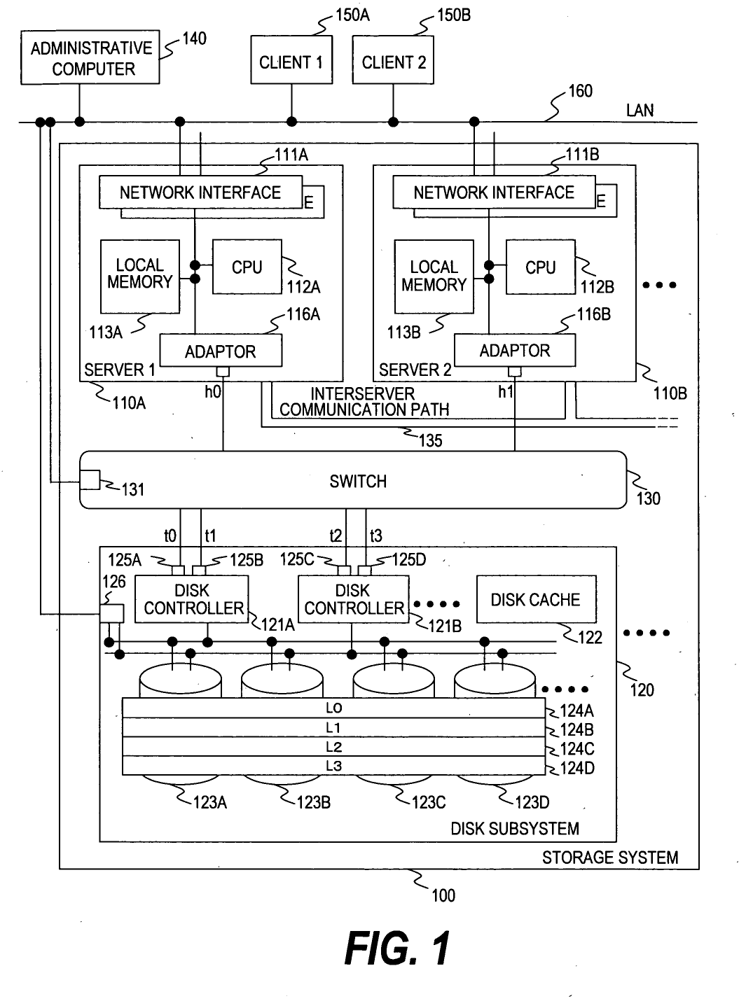

FIG. 1 is a block diagram showing a configuration of a computer system according to an embodiment of this invention.

The computer system of this embodiment has a storage system 100, an administrative computer 140, a client 150A and a client 150B, as well as a LAN 160 for interconnecting the above components.

The administrative computer 140 is a computer for instructing servers 110, for example, to create a file system in the storage system 100, to mount a file system, and to create a mirror, or instructs a disk subsystem 120 or a switch 130 to change settings.

In the following description, the term “mirror” means a replica of a file system or a replica of a directory tree which constitutes a part of the file system. Creating a mirror means that a replica is made for all data belonging to a directory tree and that the replica is stored in one of logical devices (which will be described later). A file system or a directory tree of which a replica is made is called a master.

The clients 150A and 150B are computers for accessing files in the storage system 100. Specifically, the clients 150A and 150B write files in the storage system 100 or read files out of the storage system 100. In writing or reading a file in and out of the storage system 100, a file system managed by the storage system 100 is used. The clients 150A and 150B each has, at least, a memory (not shown) which stores a program for implementing file access, and a processor (not shown) which executes the program stored in the memory.

FIG. 1 shows two clients (150A and 150B), but as many clients as desired can be connected to the LAN 160 to access the storage system 100. In the following description, the two clients 150A and 150B will generically be referred to as client 150 when there is no particular need to discriminate one from the other.

The LAN 160 is a network which uses, for example, a TCP/IP protocol for communications.

The storage system 100 is so-called network attached storage (NAS). The storage system 100 is composed of a server 110A, a server 110B, and a disk subsystem 120, as well as a switch 130 which interconnects the above components.

The switch 130 is, for example, a fibre channel (FC) switch. The storage system 100 may have a plurality of switches 130. One or more switches 130 may constitute a storage area network (SAN). Alternatively, the switch 130 may be a LAN switch or a switch dedicated to a storage system.

The servers 110A and 110B access the disk subsystem 120 in accordance with access requests made by the clients 150.

The storage system 100 has a plurality of servers including 110A and 110B. In the following description, the servers 110A and 110B will generically be referred to as server 110 when there is no particular need to discriminate one from the other. While FIG. 1 shows the two servers 110A and 110B, the storage system 100 may have more than two servers 110. The server 110 is also called a NAS head or a NAS node. A plurality of servers 110 may constitute a cluster architecture.

The server 110A has a network interface 111A, a CPU 112A, a local memory 113A, and an adaptor 116A, which are connected to one another.

The network interface 111A is an interface connected to the LAN 160 to communicate with the administrative computer 140 and the clients 150.

The CPU 112A is a processor for controlling the operation of the server 110A. Specifically, the CPU 112A executes a program stored in the local memory 113A.

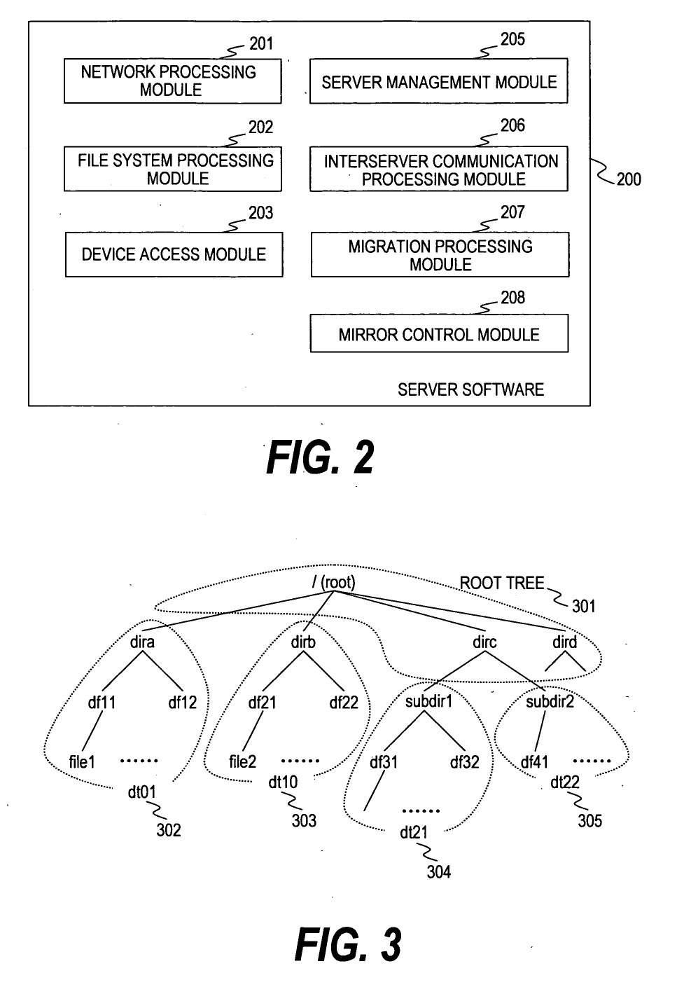

The local memory 113A is, for example, a semiconductor memory, and stores a program executed by the CPU 112A as well as data referred to by the CPU 112A. Specifically, the local memory 113A stores, in addition to server software 200 which is a program shown in FIG. 2, a mount point control table 400, a directory tree management table 500, a mirror management table 600, a file system management table 700, a mount parameter table 1500, an update client table 1600, and other data.

The adaptor 116A is an interface connected to the switch 130 to communicate with the disk subsystem 120.

The server 110B is similar to the server 110A, and has a network interface 111B, a CPU 112B, a local memory 113B, and an adaptor 116B. The network interface 111B, the CPU 112B, the local memory 113B, and the adaptor 116B are similar to the network interface 111A, the CPU 112A, the local memory 113A, and the adaptor 116A, respectively, and their descriptions are omitted here.

In the case where there are more than two servers 110, each of the servers 110 has a configuration similar to that of the server 110A.

A plurality of servers 110 in the storage system 100 are connected to one another via an interserver communication path 135. The servers 110 communicate with one another over the interserver communication path 135. Specifically, when the mount point control table 400, the mirror management table 600, or the like in one of the servers 110 is updated, the update is sent to the rest of the servers 110 via the interserver communication path 135. Each of the servers 110 that have received the update makes the update reflected on its own mount point control table 400, mirror management table 600, or the like.

The interserver communication path 135 in this embodiment is independent of the switch 130 and the LAN 160 as shown in FIG. 1. However, the servers 110 may communicate with one another via the switch 130 or the LAN 160. Alternatively, the servers 110 may use a disk cache 122 of the disk subsystem 120 in communicating with one another. In this case, an update made to the mount point control table 400 or the like in one of the servers 110 is written in the disk cache 122 by this server. Each of the rest of the servers 110 reads the update written in the disk cache 122 and updates its own mount point control table 400 or the like. The servers 100 may employ any of the above routes to communicate with one another so as to carry out this invention.

The disk subsystem 120 has a disk controller 121A, a disk controller 121B, the disk cache 122, and a disk drive 123, which are connected to one another. The disk controller 121A has ports 125A and 125B, which are connected to the switch 130. The disk controller 121B has ports 125C and 125D, which are connected to the switch 130. In the following description, the disk controllers 121A and 121B will generically be referred to as disk controller 121 when there is no particular need to discriminate one from the other. Also, the ports 125A to 125C will generically be referred to as port 125 when there is no particular need to discriminate one from the others. The disk subsystem 120 may have only one disk controller 121, or two or more disk controllers 121. Each disk controller 121 may have only one port 125, or two or more ports 125.

The disk controller 121 communicates with the servers 110 via the port 125 and the switch 130 to control the disk subsystem 120. Specifically, the disk controller 121 writes data in the disk drive 123 or reads data out of the disk drive 123 in accordance with requests from the servers 110.

The disk cache 122 is, for example, a semiconductor memory, and temporarily stores data to be written in the disk drive 123 or data read out of the disk drive 123.

The disk drives 123A to 123D are hard disk drives for storing data. The disk subsystem 120 has as many disk drives 123A, 123B, 123C . . . as desired. In the following description, the disk drives 123A to 123D will generically be referred to as disk drive 123 when there is no particular need to discriminate one from the others. The disk drives 123 may constitute redundant arrays of inexpensive disks (RAID).

Storage areas of the disk drives 123 are divided into the arbitrary number of logical devices (LDEVs). FIG. 1 shows as an example four LDEVs 124A to 124D. In the following description, the LDEVs 124A to 124D will generically be referred to as LDEV 124 when there is no particular need to discriminate one from the others. The LDEV 124 is an area treated as a logical disk drive by the disk controllers 121. When the disk drives 123 constitute RAID, storage areas of a plurality of disk drives 123 may make one LDEV 124. Each LDEV 124 can have an arbitrary size.

An LDEV identifier (ID) is assigned to each LDEV. In the example of FIG. 1, IDs L0 to L3 are given to the LDEV 124A to the LDEV 124D, respectively.

The storage system 100 may have a plurality of disk subsystems 120. In this case, the disk subsystems 120 and the servers 110 may be associated in a manner that allows one server 110 to access only a specific disk subsystem 120 or a specific group of disk subsystems 120 via the switch 130. Alternatively, each of the servers 110 may be allowed to access all the disk subsystems 120.

The switch 130 and the disk subsystem 120 have management ports 131 and 126, respectively, to be connected to the LAN 160. The administrative computer 140 refers to or updates the settings of the switch 130 or of the disk subsystem 120 via the LAN 160 and via the management port 131 or 126.

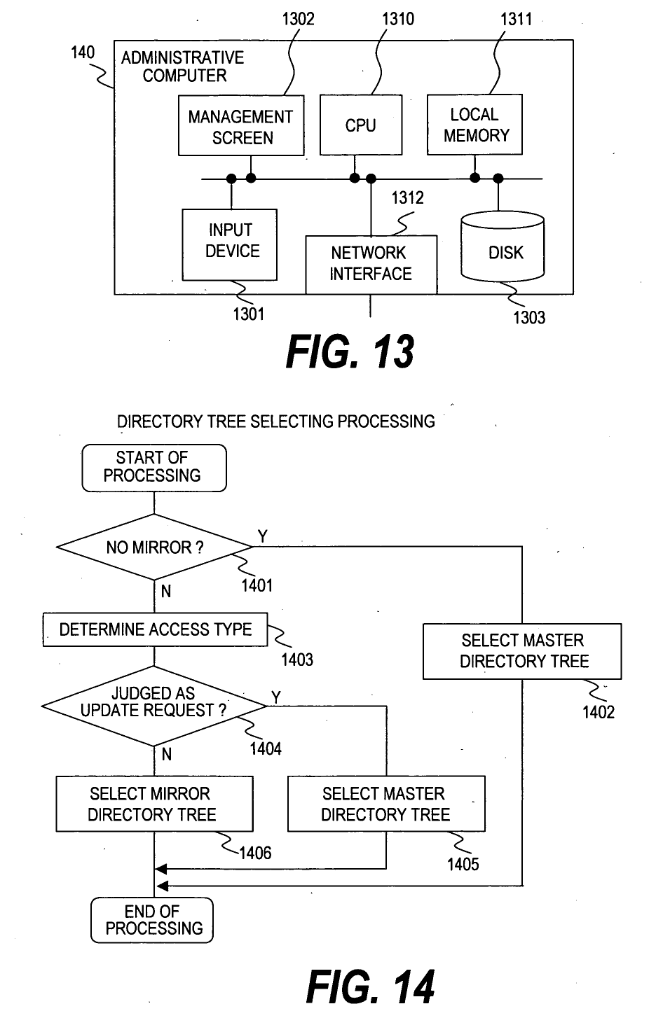

FIG. 13 is a block diagram showing a configuration of the administrative computer 140 according to the embodiment of this invention.

The administrative computer 140 has, at least, an input device 1301, a management screen 1302, a disk 1303, a CPU 1310, a local memory 1311, and a network interface 1312, which are connected to one another. The administrative computer 140 may have another configuration in which the input device 1301, the management screen 1302, and the disk 1303 are connected externally to a casing (not shown) containing the CPU 1310, the local memory 1311, and the network interface 1312.

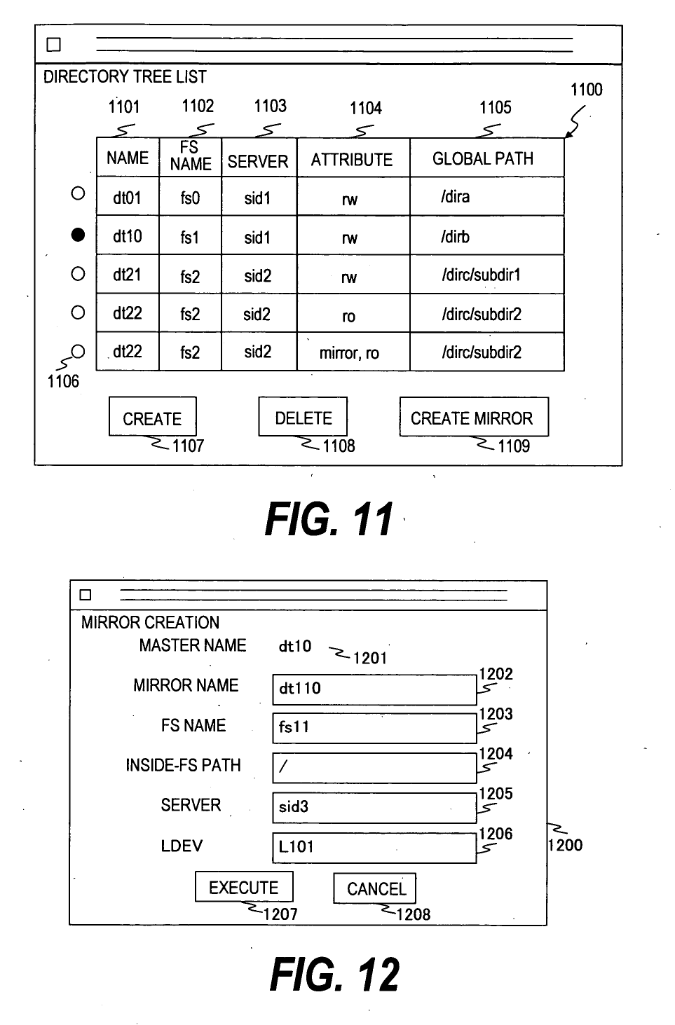

The input device 1301 is, for example, a keyboard or a pointing device which is used by a system administrator. The management screen 1302 is, for example, an image display device for displaying information to the system administrator. What is displayed on the management screen 1302 and how the computer is operated through the pointing device will be described later in detail with reference to FIGS. 11 and 12.

The disk 1303 stores, at least, a program for communicating with the servers 110 or other components and a program for managing the disk subsystem 120. These programs and others stored in the disk 1303 are read onto the local memory 1311 as the need arises and executed by the CPU 1310. The network interface 1312 is used for communicating with the servers 110 and the disk subsystem 120.

FIG. 2 is an explanatory diagram of a configuration of the server software 200 according to the embodiment of this invention.

The server software 200 includes a network processing module 201, a file system processing module 202, a device access module 203, a server management module 205, an interserver communication processing module 206, a migration processing module 207, and a mirror control module 208, which are programs executed by the CPU 112 (112A or 112B).

The network processing module 201 is a program for controlling communication with the administrative computer 140 and the client 150 via the LAN 160.

The file system processing module 202 is a program for processing a request made by the client 150 to access a file in a file system. To give a specific example, the. file system processing module 202 creates a new file system in accordance with an instruction from the administrative computer 140. To give another example, the file system processing module 202 performs name resolution and sends a file handle in response to a file handle obtaining request made by the client 150 designating a directory name or a file name. Here, the file handle is a file identifier. In the case where the directory name or file name received from the client 150 belongs to a directory tree managed by another server 110, the file system processing module 202 sends, in response to the request, the ID or other location information of the server 110 that manages the designated directory tree.

The device access module 203 is a program for executing access to data in a file system in accordance with an access request made by the client 150.

The server management module 205 is a program for communicating with the administrative computer 140 to make settings on the NAS. For instance, upon reception of an instruction to create a new file system from the administrative computer 140, the server management module 205 relays the instruction to the file system processing module 202 and causes the file system processing module 202 to create the new file system. Upon reception of a migration instruction from the administrative computer 140, the server management module 205 relays the instruction to the migration processing module 207 and causes the migration processing module 207 to execute the migration. Upon reception of an instruction to create a mirror of a directory tree from the administrative computer 140, the server management module 205 relays the instruction to the mirror control module 208 and causes the mirror control module 208 to create the mirror.

The interserver communication processing module 206 is a program for controlling communications between the servers 110 over the interserver communication path 135. For example, when the mount point control table 400 is updated in one of the servers 110, the interserver communication processing module 206 sends the update to the rest of the servers 110.

The migration processing module 207 is a program for executing migration. Migration is processing for shifting the management responsibility of a directory tree from the server 110 that is currently managing the directory tree to another server 110 designated.

As shown in the directory tree management table 500, which will be described later, each directory tree is managed by one server 110 identified by a server ID 503. When the client 150 is to access a file in a directory tree, the client's access request is processed by the server 110 that manages this directory tree. With migration which changes a server 110 to another server 110 for managing a particular directory tree, a load applied to the servers 110 can be balanced and thus the overall performance of the storage system 100 may be improved.

The mirror control module 208 is a program for executing processing to create a mirror, which is a replica of a directory tree, and processing to update the mirror. Details of the processings will be described later with reference to FIG. 9.

FIG. 3 is an explanatory diagram of a global name space provided to the client 150 according to the embodiment of this invention.

Shown in FIG. 3 are minimum directories and files necessary for explanation. Each directory tree can contain more directories and files than those shown in FIG. 3. Also, the global name space can contain more directory trees than five directory trees 301 to 305 of FIG. 3.

In FIG. 3, a directory tree that contains a root directory “/”, a directory “dirc”, and the like is mounted with other directory trees 302 to 305 in order to provide a shared name space (a global name space) to the client. This directory tree is called a root tree 301. The phrase “mounting a directory tree” means connecting a directory tree to another directory tree.

The directory trees 302 to 305 each represent the entire file system or a directory tree corresponding to a part of the file system. “dt01”, “dt10”, and other similar symbols are identifiers (IDs) assigned to the directory trees. In the following description, a directory tree that has an identifier dt01 is simply referred to as dt01. The same applies to the rest of the directory trees.

In the example of FIG. 3, dt01 has directories “df11” and “df12” under its uppermost directory, and has a file “file1” under the directory “df11”. Mounted downstream of a directory “/dira” is dt01. Accordingly, the uppermost directory of dt01 is a directory “dira” under a directory “/” (root directory). A path to the file “file1” in this case is “/dira/df11/file1”.

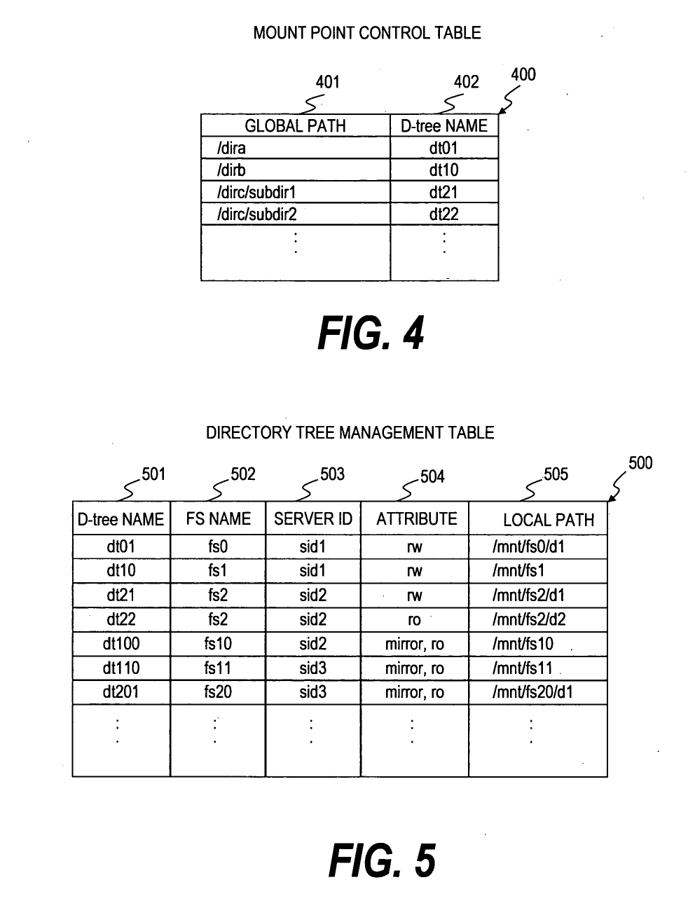

Similarly, as shown in FIG. 4, dt10 has directories “df21” and “df22” under its uppermost directory, and has a file “file2” under the directory “df22”. Mounted downstream of a directory “/dirb” is dt10. Accordingly, the uppermost directory of dt10 is a directory “dirb” under a root directory. A path to the file “file2” in this case is “/dirb/df21/file2”.

The directory tree dt21 has directories “df31” and “df32” under its uppermost directory. Mounted downstream of “/dirc/subdir1” is dt21. Accordingly, the uppermost directory of dt21 is a directory “subdir1” under the directory “dirc”, which is under a root directory.

The directory tree dt22 has directories “df41” under its uppermost directory. Mounted downstream of “/dirc/subdir2” is dt22. Accordingly, the uppermost directory of dt22 is a directory “subdir2” under the directory “dirc”, which is under a root directory.

The mount point control table 400 shown in FIG. 4 is made consistent among all the servers 110 so that the servers 110 provide the name spaces same as that shown in FIG. 3 to the clients 150. Each server 110 is capable of performing name resolution up through a mount point in a root file system and name resolution within a directory tree managed by this server 110.

For example, when the server 110A manages dt01, while the server 110B manages dt10 and the server 110B receives a request to access “/dira/df11/file1”, the server 110B can perform name resolution of the root directory but cannot perform name resolution of the directory “dira”. In this case, the server 110B refers to the mount point control table 400 and the directory tree management table 500, and judges that the directory “dira” is managed by the server 110A. Then, the server 110B sends location information (information for identifying the server 110A which manages the directory “dira”, and, if necessary, information indicating a local path in the server 110A) to the client 150 that has issued the access request. Receiving the information, the client 150 issues an access request to the server 110A and thus obtains access to “/dira/df11/file1”.

In the above example, when receiving from the client 150 a name resolution request for a file belonging to a directory tree that is not managed by the server 110B, the server 110B notifies the client 150 of the server 110A as a server that manages the directory tree. Instead of notifying the client 150, the server 110B may transfer the name resolution request received from the client 150 to the server 110A, so that the server 110A can execute the name resolution.

In the above example, each directory tree is managed by only one server 110. Alternatively, a plurality of servers 110 may share one directory tree. In this case, before updating the directory tree, the server 110 that updates the directory tree executes an operation of obtaining a lock of the directory tree so as to ensure that the directory tree is properly updated.

FIG. 4 is an explanatory diagram of the mount point control table 400 according to the embodiment of this invention.

The mount point control table 400 is a table for managing which file system in the disk subsystem 120, or which directory tree (a part of the file system), is mounted to which global name space. One entry (row) of the mount point control table 400 corresponds to one mount point.

The mount point control table 400 contains a global path 401 and a D-tree name 402. The global path 401 indicates a path in the global name space provided by the servers 110 to the clients 150 which is a mount point of each directory tree. The term mount point means a directory where each directory tree is connected to the root tree 301. The D-tree name 402 indicates the ID of a directory tree that is mounted to the global path 401.

In the example of FIG. 4, four directory trees (dt10 to dt22) are respectively mounted to directories indicated by the global path 401. Specifically, dt01 is mounted downstream of “/dira”. In a similar manner, dt10, dt21 and dt22 are mounted downstream of “/dirb”, “/dirc/subdir1” and “/dirc/subdir2”, respectively. As a result, the name space shown in FIG. 3 is provided to each of the clients 150.

FIG. 5 is an explanatory diagram of the directory tree management table 500 according to the embodiment of this invention.

The directory tree management table 500 is a table for managing all the directory trees in the storage system 100. One entry (row) of the directory tree management table 500 shows one directory tree.

A D-tree name 501 indicates a directory tree identifier (ID), which is used to identify a directory tree as the D-tree name 402 of the mount point control table 400 and a D-tree name 601 of the mirror management table 600 described later.

An FS name 502 indicates the identifier of a file system that contains a directory tree indicated by the D-tree name 501. Referring to the FS name 502 enables the servers 110 to determine which of the file systems shown in the file system management table 700 contains which directory tree.

A server ID 503 indicates an identifier unique to each server 110 which manages a directory tree. Each server 110 is allowed to access only a directory tree managed by the same. This means that, to access a file, the client 150 needs to issue an access request to the server 110 that manages a directory tree containing the file the client 150 desires to access.

In the example of FIG. 5, “sid1” is the ID of the server 110A, while “sid2” is the ID of the server 110B, and dt01 and dt10 are managed by the server 110A, while dt21 and dt22 are managed by the server 110B. An identifier “sid3” can be the ID of, for example, a server 110C, which is not shown in FIG. 1.

In the case where a directory tree is shared by a plurality of servers 110 as mentioned above, a cell for the server ID 503 contains the IDs of the plurality of servers 110. When a directory tree shared by a plurality of servers is selected in directory tree selecting processing, which will be described later, location information to be sent to a client in response to an access request is one ID selected out of a plurality of IDs registered as the server ID 503. This makes it possible to balance the load among the servers 110 that share the directory tree when access to a disk causes a bottleneck in processing in one of the servers 110, for example, as in a case where random access is the major form of access.

Migration of a directory tree changes an ID registered as the server ID 503 to another ID. For instance, migration of dt01 from the server 110A to the server 110B updates the server ID 503 in the entry for dt01 from “sid1” to “sid2”. The update is sent to every server 110 in the storage system 100 via the interserver communication path 135. Receiving the update, the server 110 updates its own directory tree management table 500. Thus, the directory tree management table 500 in every server 110 holds the same contents.

As an attribute 504, a value indicating an attribute of a directory tree is stored. A value “mirror” indicates that the directory tree is a mirror. A value “rw” (read-write) indicates that a file in the directory tree can be referred to and updated. A value “ro” (read only) indicates that a file in the directory tree can be referred to but cannot be updated.

In the case where masters alone are updated, the attribute 504 of the masters is “rw”, while “ro” is written as the attribute 504 of mirrors.

Referring to the attribute 504 enables the servers 110 to judge whether a directory tree is a master or a mirror. Determination as to whether a directory tree is a master or a mirror can also be made by judging whether or not the ID of this directory tree is registered as the mirror name 602 in the mirror management table 600, which will be described later. Therefore, it is not always necessary to register the value “mirror” as the attribute 504.

A local path 505 indicates a path in a local name space inside the server 110 where the substance of a directory tree identified by the D-tree name 501 is located. For example, in a global name space created in accordance with the mount point control table of FIG. 4 and the directory tree management table of FIG. 5, a file expressed as “/dirb/df21/file2” is a file managed by the server 110A, which is the server 110 identified by the identifier “sid1”, and a path to this file is “/mnt/fs1/df21/file2”.

The example described above shows a case in which a path in a global name space differs from a local path in the server 110. In the case where the two paths are the same, there is no particular need for the directory tree management table 500 to have the local path 505. For instance, when the dt01's local path in the server 110 that has the identifier sid1 is “/dira”, this local path is the same as the path in the global name space. Then, location information to be sent to the client 150 does not need to contain a local path.

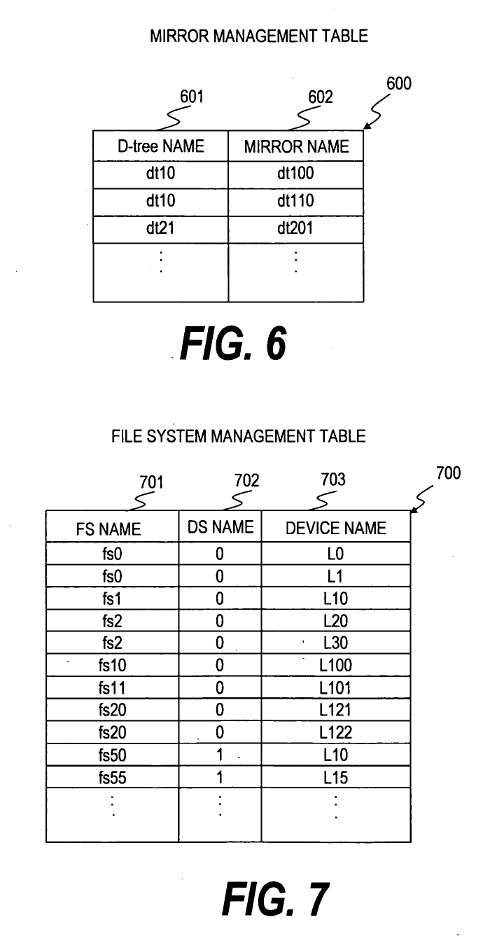

FIG. 6 is an explanatory diagram of the mirror management table 600 according to the embodiment of this invention.

The mirror management table 600 is a table showing the association between a mirror, which is a replica of a directory tree, and a master, which is a directory tree from which the mirror is created. One entry (row) of the mirror management table 600 shows one mirror. A mirror is a directory tree that has the same data as its master. Data in a mirror can be referred to but updating the data is prohibited.

The D-tree name 601 indicates the ID of a master directory tree. A mirror name 602 indicates the ID of a mirror directory tree.

In the case where there are a plurality of mirrors for one master, the mirror management table 600 holds a plurality of entries that have the same D-tree name 601. Entries of the mirror management table 600 are desirably sorted by the D-tree name 601, so that a mirror or mirrors of a master can readily be found when the table is searched with a D-tree name as a key.

In the example of FIG. 6, “dt10”, “dt10”, and “dt2l” as the D-tree name 601 are registered in association with “dt100”, “dt110”, and “dt210”, respectively, as the mirror name 602. This shows that dt100 and dt110 are mirrors of dt10, and that dt201 is a mirror of dt21.

FIG. 7 is an explanatory diagram of the file system management table 700 according to the embodiment of this invention.

The file system management table 700 is a table for managing file systems contained in the storage system 100, and shows the logical devices (LDEVs) 124 of the disk subsystem 120 where the file systems are stored. Each entry (row) of the file system management table 700 corresponds to one LDEV 124.

An FS name 701 indicates the ID of a file system. A DS name 702 indicates the ID of the disk subsystem 120 that contains the LDEV 124 where the file system identified by the FS name 701 is stored. A device name 703 indicates an ID used within the disk subsystem 120 to identify the LDEV 124 where the file system identified by the FS name 701 is stored.

One file system can be stored in a plurality of LDEVs 124. In this case, the file system management table 700 holds a plurality of entries that have the same FS name 701. Entries of the file system management table 700 are desirably sorted by the FS name 701, so that a group of LDEVs 124 that together store one file system can readily be found when the table is searched with a file system name as a key.

In the example of FIG. 7, “fs0” is registered as the FS name 701 in two entries, and “0” is registered as the DS name 702 in these two entries. In one of the two entries for “fs0”, “L0” is registered as the device name 703, while “L1” is registered as the device name 703 in the other entry for “fs0”. This shows that the file system “fs0” is stored in two LDEVs 124 that have device names “L0” and “L1” and that are stored in the disk subsystem 120 whose DS name is “0”.

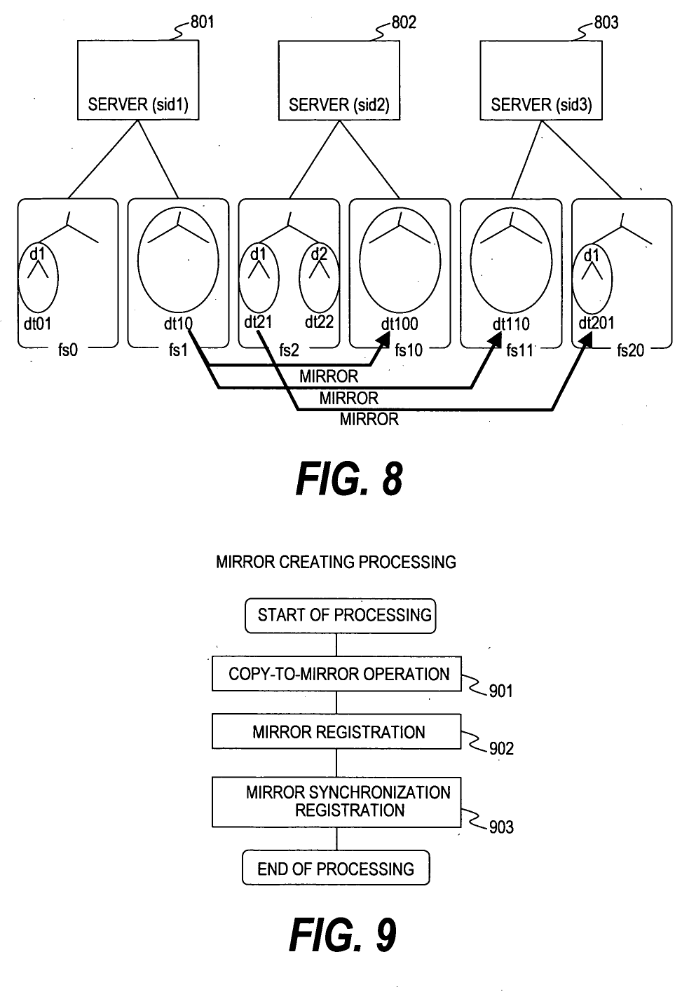

FIG. 8 is an explanatory diagram showing mirror relations in the embodiment of this invention.

FIG. 8 takes as an example the directory tree-mirror relations that are shown in the example of the directory tree management table 500 of FIG. 5 and the example of the mirror management table 600 of FIG. 6.

In this example, two mirrors (dt100 and dt110) have dt10 as their master, while one mirror (dt201) has dt21 as its master. A master and mirrors of the master are all managed by different servers 110.

Thus creating mirrors of one directory tree (master) and placing the mirrors which have the same data as the master in a plurality of servers 110 makes it possible to allocate requests to access the master to the servers 110 that have the mirrors and to balance the load among the servers 110.

A mirror is created by the mirror control module 208 of the server software 200 upon reception of an instruction from the administrative computer 140 as shown in FIG. 9.

Described above is a case in which master and mirrors of the master are all managed by different servers 110. Alternatively, some of them may be managed by the same server 110. This option is effective when a heavy load is being applied to a directory tree and the LDEV 124 that stores this directory tree is causing a performance bottleneck. Specifically, the performance can be improved by balancing the load on a directory tree among a plurality of LDEVs 124.

In this case, a global path and a local path have to be different paths and mirrors managed by the same server 110 have to have different local paths.

Now, processing executed by the programs that are contained in the server software 200 will be described with reference to flow charts. The server software 200 is stored in the local memory 113 and the programs contained in the server software 200 are executed by the CPU 112. Accordingly, processing executed by the programs in the following description is actually executed by the CPU 112.

FIG. 9 is a flow chart for mirror creating processing which is executed by the mirror control module 208 according to the embodiment of this invention.

The mirror creating processing is started upon reception of an instruction from the administrative computer 140.

The mirror control module 208 first executes copy-to-mirror operation 901. Specifically, the mirror control module 208 copies all data in a master directory tree.

In the case where the disk controller 125 has a data copy function, the mirror control module 208 sends a copy execution instruction to the disk controller 125 via the device access module 203.

Receiving the instruction, the disk controller 125 executes data copy sequentially. When data to be copied is updated during the copy, the disk controller 125 executes double write in which copy source data and copy destination data are both updated. This makes the copy destination data consistent with the copy source data. The double write processing is continued after the sequential data copy is finished, until a disconnection instruction is received from the server 110.

In the case where the LDEV 124 that stores a copy destination directory tree (i.e., a mirror) and the LDEV 124 that stores a copy source directory tree (i.e., a master) belong to different disk subsystems 120, the disk controller 125 executes copy by sending data via the switch 130 to the disk controller 125 that manages the copy destination LDEV 124.

After the data copy is finished, the disk controller 125 disconnects the mirror from the master and mounts a file system that contains the mirror to the server 110 (in other words, executes processing of connecting the file system to a local path in the server 110) if necessary.

The copy-to-mirror operation 901 may be executed by the server 110 when the disk controller 125 does not have a data copy function. In this case, the mirror control module 208 instructs the file system processing module 202 to execute copy. The file system processing module 202 first mounts, if necessary, a file system that contains a directory tree to which data is to be copied. The file system processing module 202 then executes data copy sequentially. In the case where data to be copied is updated, the file system processing module 202 executes double write similar to the one executed by the disk controller 125. This makes the copy destination data consistent with the copy source data. The double write processing is continued after the sequential data copy is finished, until a disconnection instruction is received from the server 110.

In the case where the copy destination is a directory tree that is managed by another server 110, copy is executed by sending data via the LAN 160 or the interserver communication path 135 to the server 110 that manages the copy destination directory tree.

In some cases, the configuration of a master directory tree is limited when the disk controller 125 creates a mirror. The copy function of the disk controller 125 usually manages copy on an LDEV-to-LDEV basis. Accordingly, when there are a plurality of directory trees in one LDEV 124, it is not possible for the disk controller 125 to copy only one of the directory trees. The disk controller 125 solves this by associating a group of LDEVs 124, a file system, and a directory tree on a one-on-one basis and creating a mirror of the group of LDEVs 124. Alternatively, when a group of LDEVs 124 is allowed to have a plurality of directory trees and a mirror is to be created for one of the directory trees, mirrors may be created for all of the plurality of directory trees contained in the group of LDEVs 124.

On the other hand, when it is the server 110 that creates a mirror, there are no limitations on the relation between a master directory tree and a file system or the LDEV 124 and a mirror can be created for a designated directory tree alone. For instance, the server 110 can create mirrors of a plurality of directory trees in one file system in different file systems. The server 110 can also create in one file system mirrors of a plurality of directory trees that are in different file systems.

After the copy-to-mirror operation 901 is completed, the mirror control module 208 executes mirror registration 902. Through the mirror registration 902, entries are added to the directory tree management table 500 and the mirror management table 600. For instance, when dt100 is created as a mirror of dt10, an entry that has dt100 as the D-tree name 501 is added to the directory tree management table 500 as shown in FIG. 5 while an entry that has dt10 as the D-tree name 601 and dt100 as the mirror name 602 is added to the mirror management table 600 as shown in FIG. 6.

If necessary, the mirror registration 902 is followed by mirror synchronization registration 903 which is executed by the mirror control module 208. Through the mirror synchronization registration 903, a schedule of mirror synchronization processing for reflecting an update made to a master on a mirror is set to the disk controller 125 or the file system processing module 202.

The mirror control module 208 may be set such that the mirror synchronization processing is executed at five-second intervals, for example. The mirror synchronization processing is processing for making data in a mirror consistent with data in its master by writing, in the mirror, as differential information, a data update that is made after the mirror synchronization processing is executed last time. In the case where the mirror synchronization processing is executed by the copy function of the disk controller 125 and the server 110 keeps as a cache data that is once read onto its own local memory 113, the server 110 needs to clear the cache so that the server 110 refers to an update reflected on the LDEV 124. Then, the mirror control module 208 has the file system processing module 202 of the server 110 clear the cache as the mirror synchronization processing.

In some cases, the mirror synchronization processing has to be executed at a pause in a series of updates made to a directory tree. Examples of such cases include when an application run on the client 150 updates a file along a directory tree and when synchronization is to be executed after an update constituted of a plurality of requests is completed.

Therefore, execution of the mirror synchronization processing may be timed with collection of snapshots. The snapshot collection is processing of keeping data of a file system at one point for backup or other purposes. A mirror may be created by copying a snapshot of a master instead of copying a master file system. In this case, when the server 110 or the disk controller 125 has a copy function for copying a snapshot to another server or other similar functions, this copy function can be used in executing the copy-to-mirror operation 901.

The mirror synchronization registration 903 is not necessary when a master and its mirror are always in sync with each other. In other words, the mirror synchronization registration 903 is unnecessary when double write of an update is constantly executed without disconnecting a mirror from its master after the sequential data copy is finished in the copy-to-mirror operation 901.

However, in the case where the disk controller 125 executes double write and the server 110 has a cache, the processing of having the file system processing module 202 of the server 110 clear the cache is necessary. The mirror synchronization registration 903 therefore has to be executed in order to regularly clear the cache.

Update requests are executed only for masters and reference requests alone are executed for mirrors through directory tree selecting processing, which will be described later with reference to FIG. 14. In other words, only masters which have the latest information are updated without exception, and thus the update order is kept all the time. Accordingly, an update made to a master does not need to be reflected immediately on its mirror, and it is possible to make the update reflected on the mirror after a delay from the time the master is updated (so that the mirror is updated periodically, for example).

Making update data of a master reflected on a mirror through the mirror synchronization processing instead of immediately updating the mirror with the update data eliminates the need to obtain a lock in updating the master and the need to wait for completion of update to the mirror. This makes high-speed master update processing possible.

After the mirror synchronization registration 903 is finished, the mirror control module 208 notifies the administrative computer 140 of the completion of the processing via the server management module 205.

When an access request is received from the client 150 after a mirror is created, the file system processing module 202 selects a master directory tree or one of mirror directory trees and allocates the access request to the selected directory tree.

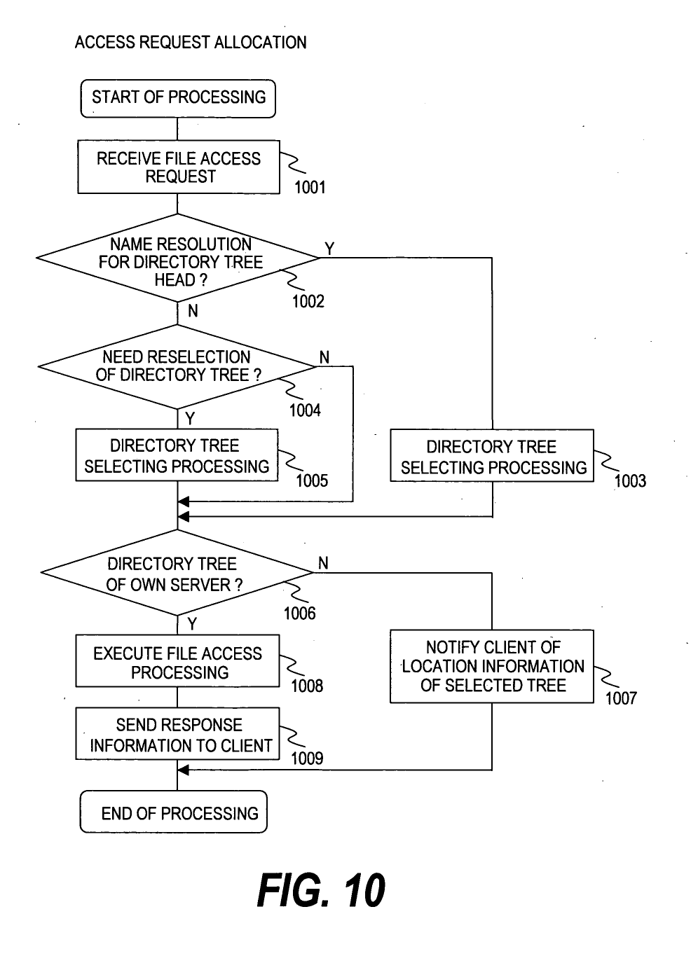

FIG. 10 is a flow chart for processing that is executed by the file system processing module 202 to allocate access requests according to the embodiment of this invention.

Access request allocation may be executed each time an access request is made, but this allocation method increases overhead. Desirably, access request allocation is executed for each client 150 that makes access requests. In this case, once allocation is executed, each client 150 issues access requests to one selected directory tree until next time allocation is executed.

The file system processing module 202 receives a file access request from the client 150 via the network processing module 201 (Step 1001).

Next, the file system processing module 202 judges whether or not the received request is about name resolution for a directory tree head (Step 1002).

When it is judged in Step 1002 that the received request is about name resolution for a directory tree head, the file system processing module 202 calls up directory tree selecting processing (Step 1003). The processing then proceeds to Step 1006.

When it is judged in Step 1002 that the received request is not about name resolution for a directory tree head, the file system processing module 202 judges whether or not it is necessary to select a directory tree anew (Step 1004).

When it is judged in Step 1004 that reselection of a directory tree is necessary, the file system processing module 202 calls up the directory tree selecting processing (Step 1005).

Directory tree reselection is necessary when, for example, an access request is received after a new mirror is created. In this case, the reselection is executed in order to distribute access requests to the newly created mirror. Another example is when there is a change in pattern of access from the client 150 with the result that a particular master or mirror receives an unproportionally large number of access requests. In this case, the reselection is executed in order to even out the load among masters and mirrors.

In the above cases, the directory tree reselection is executed for access that is made to one directory tree within a given period of time. When one of the above events happens, a flag (not shown) is set for each directory tree and the file system processing module 202 judges in Step 1004 that the reselection is necessary while the flag remains set. The flag is removed after a given period of time passes.

Still another example in which the reselection is judged as necessary is when a request to update a mirror is issued. Selecting mirrors until an update request is received from the client 150 is one of selection methods employed by the directory tree selecting processing, which will be described later. According to this method, in the case where an access request received after a selection is made is an update request, the reselection is executed to select a master.

The file system processing module 202 judges whether or not the access request is directed to its own server 110 (the server 110 to which the CPU 112 executing Step 1006 belongs) (Step 1006). In the case where Step 1003 or Step 1005 is executed, “the destination of the access request” in Step 1006 is the directory tree that is selected in Step 1003 or Step 1005.

When it is judged in Step 1006 that a directory tree requested for access is not one that is managed by its own server 110, the file system processing module 202 sends location information of the directory tree to the client 150 (Step 1007) and ends the processing. This location information contains the identifier of the server 110 that manages the directory tree requested for access. Receiving the location information, the client 150 issues an access request anew to the designated directory tree that the server 110 specified by the received location information manages.

When it is judged in Step 1006 that a directory tree requested for access is one that is managed by its own server 110, the file system processing module 202 executes file access processing (Step 1008), sends the result of the file access processing as response information to the client 150 (Step 1009), and then ends the processing.

FIG. 14 is a flow chart for the directory tree selecting processing which is executed by the file system processing module 202 according to the embodiment of this invention.

The directory tree selecting processing is called up in Step 1003 and Step 1005 of FIG. 10.

The file system processing module 202 refers to the directory tree management table 500 and the mirror management table 600 in executing the directory tree selecting processing.

First, the file system processing module 202 judges whether or not there is a mirror of a directory tree that is requested by the client 150 for access (Step 1401). Specifically, when the directory tree requested for access itself is a mirror, or when the directory tree requested for access is a master and the ID of this directory tree has been registered as the D-tree name 601 in the mirror management table 600, it is judged that there is a mirror. Whether or not the directory tree requested for access is a mirror can be judged by referring to the attribute 504 of the directory tree management table 500.

When it is judged in Step 1401 that there is no mirror, the file system processing module 202 selects a master (Step 1402) and ends the processing.

When it is judged in Step 1401 that there is a mirror, the file system processing module 202 determines what type of access is made (Step 1403). Specifically, the file system processing module 202 judges whether or not the client 150 that has issued the access request has a possibility of issuing at least one of update requests.

The processing branches based on the judgment result in Step 1403 (Step 1404). Specifically, when it is judged in Step 1403 that the client 150 has a possibility of issuing at least one of update requests, the file system processing module 202 selects a master directory tree (Step 1405) and ends the processing. When it is judged in Step 1403 that the client 150 does not have a possibility of issuing at least one of update requests, the file system processing module 202 selects a mirror directory tree (Step 1406) and ends the processing.

Finding a plurality of mirrors in Step 1401 means that the mirror management table 600 has a plurality of entries that have the same D-tree name 601. In this case, one of the plurality of entries is selected. This selection can be made by various methods. For instance, the round robin method may be employed, or a mirror with a light load may be selected by checking how much load is being applied to the mirrors at the time the selection is made.

The above example shows a case in which mirrors are not updated. However, it is possible to permit updates to some of mirrors when, for example, updates are too frequent to process solely with masters. In this case, “rw” is written as the attribute 504 in entries of the directory tree management table 500 for mirrors that are allowed updates, despite them being mirrors. Then, a master or one of the mirrors that have “rw” as the attribute 504 is selected in Step 1405 when it is judged in Step 1403 that the client 150 has a possibility of issuing at least one of update requests.

In the case where an update to a mirror is permitted, data in the mirror must always be consistent with data in its master and, accordingly, an update of the mirror has to be synchronized with an update of the master. For example, the double write processing described above may constantly be performed on a mirror that is allowed updates. It is also necessary to control a lock or the like for a master and a mirror that is allowed updates in order to avoid making different updates to the master and the mirror simultaneously. The update synchronization or lock control or the like is not necessary for mirrors that are not allowed updates (that is, reference-only mirrors).

The access type determination in Step 1403 is specifically judgment about whether or not an access request made by the client 150 contains an update request. There are several methods to determine the type of access, and one of the methods may be selected or some of the methods may be used in combination. Four typical determination methods will be described below. Other determination methods than the four described below may also be employed.

A first determination method in Step 1403 is to judge that the client 150 does not have a possibility of issuing at least one of update requests until the client 150 actually makes an update. In other words, when the server 110 first receives from the client 150 a request to access a directory tree, it is judged that the client 150 does not have a possibility of issuing at least one of update requests and, when the same client 150 makes a request to update the same directory tree, it is judged that the client 150 has a possibility of issuing at least one of update requests. Whether or not there is a possibility to be issued at least one of update requests is issued may be judged from the type of access request referred to each time an access request is received. In this case, the file system processing module 202 judges in Step 1403 whether or not the received access request is an update request. When the received access request is not an update request (for example, when the received request is a reference request), it is judged that the client 150 does not have a possibility of issuing at least one of update requests, and a mirror is selected. In the case where this client 150 issues an update request after that, it is judged in Step 1004 that the reselection is necessary and the directory selecting processing is called up. In this case, the file system processing module 202 judges that the client 150 has a possibility of issuing at least one of update requests (Step 1403) and selects a master (Step 1405).

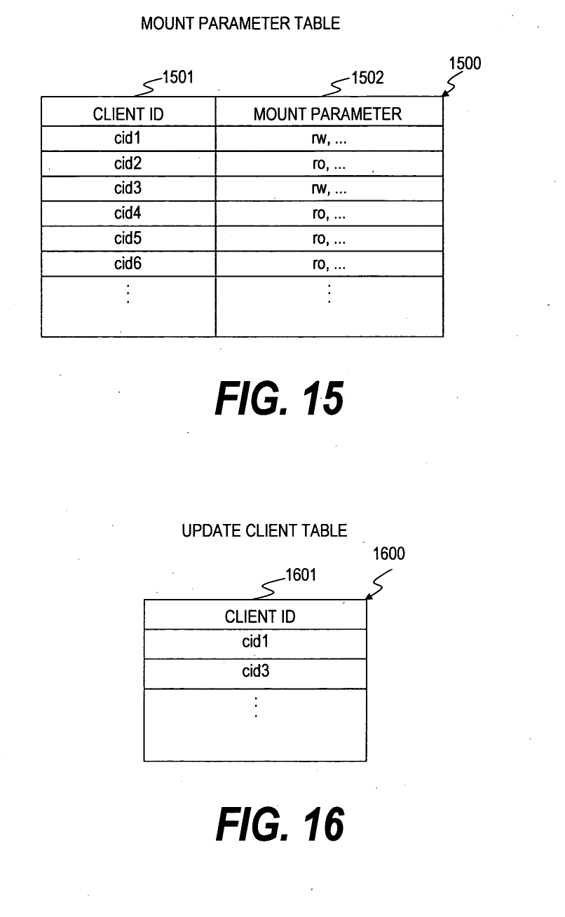

A second determination method in Step 1403 is to judge from a parameter set by the client 150. Specifically, when the client 150 executes mounting (that is, when the client 150 first accesses a global name space) or the like, a mount parameter (described later) indicating whether the client 150 has a possibility of issuing at least one of update requests or not is set. The set mount parameter is registered in the mount parameter table 1500 as shown in FIG. 15. For instance, a user of the client 150 may designate a mount parameter, which is then set by the client 150.

According to this method, the file system processing module 202 refers to the registered mount parameter in Step 1403. In the case where the mount parameter is a value indicating that no update request is issued (e.g., a value indicating that a reference request alone is issued), the file system processing module 202 judges that the client 150 does not have a possibility of issuing at least one of update requests and selects a mirror (Step 1406). In the case where the mount parameter is a value indicating that an update request is issued, the file system processing module 202 judges that the client 150 has a possibility of issuing at least one of update requests and selects a master (Step 1405).

FIG. 15 is an explanatory diagram of the mount parameter table 1500 according to the embodiment of this invention.

The mount parameter table 1500 is stored in the local memory 113 and referred to by the file system processing module 202. The mount parameter table 1500 is composed of a client ID 1501 and a mount parameter 1502.

The client ID 1501 indicates the identifier (ID) of the client 150 that executes mounting. For example, a host name, an IP address or the like that is assigned to the client .150 can be registered as the client ID 1501.

The mount parameter 1502 indicates a parameter set by the client 150 when mounting is executed. Specifically, a parameter indicating the type of access request issued by the client 150 is registered as the mount parameter 1502. For example, in the case where the client 150 has a possibility of issuing at least one of update requests and at least one of reference requests both, “rw” is registered as the mount parameter 1502 in an entry that has the ID of this client 150 as the client ID 1501. In the case where the client 150 issues only a reference request, “ro” is registered as the mount parameter 1502 in an entry that has the ID of this client 150 as the client ID 1501.

To give an example, a description is given on a case in which the client 150A of FIG. 1 has “cid1” as the client ID 1501 and the client 150B has “cid2” as the client ID 1501. The file system processing module 202 receives an access request from the client 150A and judges that the client 150A has a possibility of issuing at least one of update requests from the fact that the mount parameter 1502 in an entry for “cid1” is “rw” (Step 1403). The file system processing module 202 receives an access request from the client 150B and judges that the client 150B does not have a possibility of issuing at least one of update requests from the fact that the mount parameter 1502 in an entry for “cid2” is “ro” (Step 1403).

A third determination method in Step 1403 is to register the client 150 that has a possibility of issuing at least one of update requests. Specifically, the system administrator or a user of the client 150, for example, registers the client 150 that may issue at least one of update requests in the update client table 1600, which is stored in the local memory 113 as shown in FIG. 16.

According to this method, the file system processing module 202 refers to the update client table 1600 in Step 1403. In the case where the received access request is issued from the client 150 that is registered in the update client table 1600, the file system processing module 202 judges that this client 150 has a possibility of issuing at least one of update requests and selects a master (Step 1405). In the case where the received access request is issued from the client 150 that is not registered in the update client table 1600, the file system processing module 202 judges that this client 150 does not have a possibility of issuing at least one of update requests and selects a mirror (Step 1406).

In the above example, the client 150 that has a possibility of issuing at least one of update requests is registered in the update client table 1600. The reverse is possible and the client 150 that has no possibility of issuing at least one of update requests may be registered in a table. In this case, when the client 150 that has issued the access request is registered in the table, it is judged in Step 1403 that this client 150 does not have a possibility of issuing at least one of update requests.

FIG. 16 is an explanatory diagram of the update client table 1600 according to the embodiment of this invention.

The client table 1600 is stored in the local memory 113 and referred to by the file system processing module 202. The client table 1600 includes a client ID 1601.

The client ID 1601 indicates the identifier (ID) of the client 150 registered by the system administrator or the like. A host name, an IP address, or the like that is assigned to the client 150 can be registered as the client ID 1601. The system administrator or the like registers the identifier of the client 150 that has a possibility of issuing at least one of update requests as the client ID 1601.

To give an example, a description is given on a case in which the client 150A of FIG. 1 has “cid1” as the client-ID and the client 150B has “cid2” as the client ID. The file system processing module 202 receives an access request from the client 150A and judges that the client 150A has a possibility of issuing at least one of update requests from the fact that “cid1” is registered as the client ID 1601 (Step 1403). The file system processing module 202 receives an access request from the client 150B and judges that the client 150B does not have a possibility of issuing at least one of update requests from the fact that “cid2” is not registered as the client ID 1601 (Step 1403).

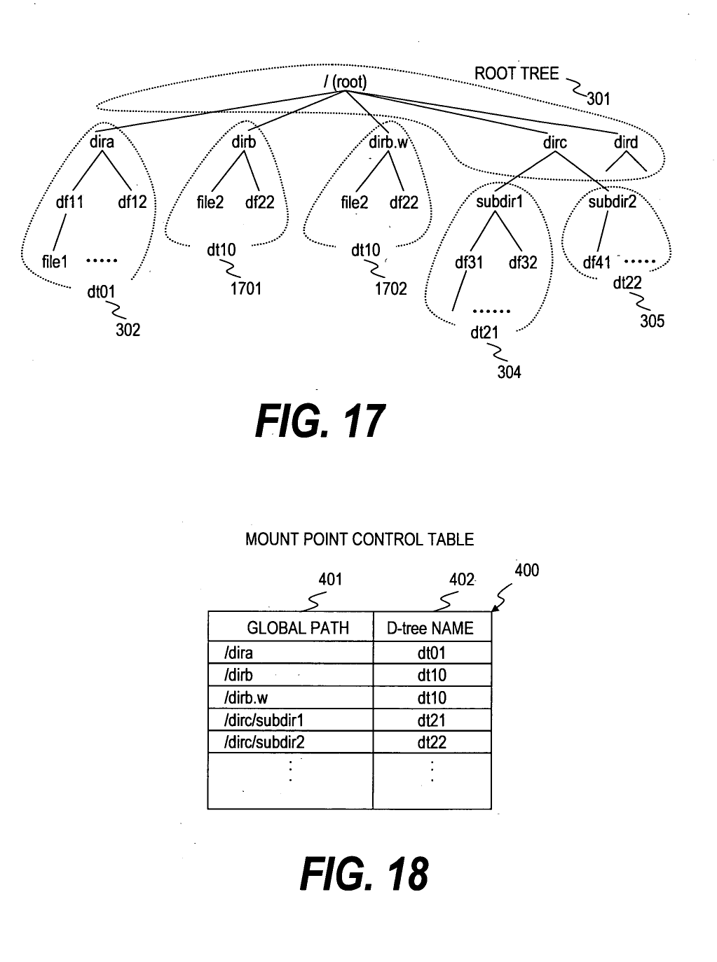

A fourth determination method in Step 1403 of FIG. 14 is to set different global name space paths for different access types. In issuing an update request, the client 150 uses a path different from the one used in issuing a reference request even when it is the same file that the update request and the reference request are requesting access. For example, a directory “/dirb.w” is prepared for the directory “/dirb” of the directory tree 303 shown in FIG. 3. Specifically, a directory tree prepared in order to issue an update request is registered in the mount point control table 400 by a directory name that is obtained by adding “.w” to the original directory name (e.g., “/dir.w”). In this case, name spaces provided to clients have two types of directory, one with an additional “.w” and one without the additional “.w”. For instance, name spaces provided to clients contain two directories “/dirb” and “/dirb.w” as shown in FIGS. 17 and 18 after an entry for “/dirb.w” is added.

In the case where the above two directory names are registered, the client 150 displays to its user a screen for selecting from the two directories. To update a file “file2” under “/dirb”, for example, the user selects “/dirb.w” and enters the selected directory name in the client 150, while the user selects and enters “/dirb” in order to refer to “file2”. This causes the client 150 to use a path “/dirb/file2” in issuing a request to refer to “file2” under the directory “/dirb” and, in issuing a request to update the same file, to use a path “/dirb.w/file2”. The file system processing module 202 checks a path that is used for the access request received from the client 150 (Step 1403). When it is found as a result that the former path is used, the file system processing module 202 judges that the client 150 does not have a possibility of issuing at least one of update requests and selects a mirror (Step 1406). In the case where the latter path is used, the file system processing module 202 judges that the client 150 has a possibility of issuing at least one of update requests and selects a master (Step 1405).

FIG. 17 is an explanatory diagram of a name space provided to the client 150 when path names are served as a basis to judge whether or not there is an update request according to the embodiment of this invention.

The root tree 301 and the directory trees 302, 304, and 305 in FIG. 17 are the same as those shown in FIG. 3, and a description of the trees is therefore omitted here. The example of FIG. 17 has additional directory trees 1701 and 1702 under the root directory “/”.

The uppermost directory of the directory tree 1701 is “dirb” under the root directory. A file “file2” and a directory “df22” are located under the directory “dirb”.

The uppermost directory of the directory tree 1702 is “dirb.w” under the root directory. Located under the directory “dirb.w” are the same file and directory that are placed in the directory tree 1701.

The directory trees 1701 and 1702 have the same identifier “dt10”.

FIG. 18 is an explanatory diagram of the mount point control table 400 of when whether or not there is an update request is judged from path names according to the embodiment of this invention.

Shown in FIG. 18 is an example of the mount point control table 400 based on the name space of FIG. 17. A description will be omitted about a part of FIG. 18 that is similar to FIG. 4.

In FIG. 18, “/dirb.w” is registered as the global path 401 in addition to “/dirb”. The entry whose global path 401 is “/dirb” and the entry whose global path 401 is “/dirb.w” both have “dt10” as the D-tree name 402. The rest of the entries shown in FIG. 18 are the same as those shown in FIG. 4.

The client 150 displays to its user a screen for selecting one of “/dirb” and “/dirb.w” as mentioned above. For that reason, the mount point control table 400 is also stored in a memory (not shown) of the client 150 in the case where the fourth method is employed in Step 1403 of FIG. 14.

The description given next is about an interface for managing the storage system 100 according to the embodiment of this invention. The interface is provided to an administrator of the storage system 100 by the administrative computer 140.

FIG. 11 is an explanatory diagram of a directory tree list displaying screen which is displayed on the management screen 1302 according to the embodiment of this invention.

The directory tree list displaying screen contains a directory tree list 1100, a “create” button 1107, a “delete” button 1108, and a “create mirror” button 1109.

The directory tree list 1100 is composed of a name 1101, an FS name 1102, a server 1103, an attribute 1104, and a global path 1105.

The name 1101 indicates the name of a directory tree. In the example of FIG. 11, the same directory trees that are shown in FIG. 3 are displayed.

The FS name 1102 indicates the name of a file system that contains the directory tree identified by the name 1101.

The server 1103 indicates the identifier of the server 110 that manages the directory tree identified by the name 1101. In the example of FIG. 11, the association between directory trees and the servers 110 that manage the directory trees is the same as in FIG. 5, and values registered as the server ID 503 shown in FIG. 5 are displayed as the server 1103.

Displayed as the attribute 1104 is attribute information of each directory tree. Values registered as the attribute 504 in the directory tree management table 500 are displayed as the attribute 1104.

The global path 1105 indicates a mount point in a global name space of the directory tree identified by the name 1101. In the example of FIG. 11, the same mount points that are registered as the global path 401 shown in FIG. 4 are set as the global path 1105.

The create button 1107 is used in creating a new directory tree.

The delete button 1108 is used in deleting a directory tree. For example, the administrator selects a directory tree to be deleted and operates the delete button 1108, thereby deleting the selected directory tree. To select a directory tree, a circle 1106 to the left of the column of the name 1101 shown in FIG. 11 may be operated with a pointing device (not shown) (for example, by clicking on the circle with a mouse). The delete button 1108 is similarly operated.

The create mirror button 1109 is used in creating a mirror of a directory tree. For example, when the administrator selects one directory tree and operates the create mirror button 1109, another screen shown in FIG. 12 is displayed, so that a mirror can be created on the new screen. Directory trees selected in this case are master directory trees.

FIG. 12 is an explanatory diagram of a mirror creating operation screen 1200 which is displayed on the management screen 1302 according to the embodiment of this invention.

The mirror creating operation screen 1200 is displayed when the administrator selects a master directory tree and operates the create mirror button 1109 on the directory tree list displaying screen shown in FIG. 11. FIG. 12 shows as an example the mirror creating operation screen 1200 displayed when the administrator selects dt10 on the directory tree list displaying screen.

The mirror creating operation screen 1200 contains a master name displaying field 1201, a mirror name entering field 1202, an FS name entering field 1203, an inside-FS path entering field 1204, a server entering field 1205, an LDEV entering field 1206, an “execute” button 1207, and a “cancel” button 1208.

The name displaying field 1201 displays the name of the directory tree selected by the administrator. In the example of FIG. 12, dt10 is displayed in the name displaying field 1201. The administrator enters in the mirror name entering field 1202 the name of a mirror that is to be newly created. In the example of FIG. 12, “dt110” is entered in the mirror name entering field 1202. The administrator enters in the FS name entering field 1203 the name of an FS where the newly created mirror is to be stored. In the example of FIG. 12, “fs11” is entered in the FS name entering field 1203. The administrator enters in the inside-FS path entering field 1204 the path name of a head directory in the FS of the newly created mirror. In the example of FIG. 12, “/” is entered in the inside-FS path entering field 1204. This means that the entire fs11 serves as the directory tree dt110. The administrator enters in the server entering field 1205 the name of the server 110 that is to manage the new mirror. In the example of FIG. 12, “sid3” is entered in the server entering field 1205. The administrator enters in the LDEV entering field 1206 the name of an LDEV where the new mirror is to be stored. When the new mirror is to be stored in a plurality of LDEVs, the names of the plurality of LDEVs are entered with commas “,” separating one from another. In the example of FIG. 12, “L101” is entered in the LDEV entering field 1206.

Filling the fields as shown in the example of FIG. 12 creates a directory tree that corresponds to an entry for dt110 in the directory tree management table 500 of FIG. 5.

It is not always necessary to enter values in all the entering fields (1202 to 1206) of the mirror creating operation screen 1200. For instance, in the case of newly creating a mirror directory tree in a part of an existing file system, which server 110 manages the new directory tree and which LDEV 124 stores the new directory tree are determined by the name of the FS. Accordingly, there is no need to fill the server entering field 1205 and the LDEV entering field 1206 (values entered in these fields are ignored in this case). To give another example, in the case where the mirror to be created uses up the entire FS, the configuration of the directory tree determines an inside-FS path and-therefore the inside-FS path entering field 1204 does not need to be filled.

The execute button 1207 is used in executing mirror creation. Operated by the administrator, the execute button 1207 starts processing of creating a mirror of dt10 in the server 110 that has the identifier sid3. The cancel button 1208 is used in stopping the mirror creation operation. When the administrator operates the cancel button 1208, the mirror creating operation screen 1200 is closed and the directory tree list displaying screen is displayed again.

As has been described, this embodiment enables the storage system 100 having a plurality of servers 110 to balance the reference load among the servers 110 by creating a mirror of the entire file system or a mirror of a part of a file system. The entire file system or the part of the file system is referred to as “directory tree”. This embodiment also makes it possible to update, without taking such measures as keeping the order of update among the servers 110 and implementing lock control, a directory tree that has a plurality of mirrors by determining the type of access from the client 150 and allocating access requests that contain update requests only to masters. Moreover, an update made to a master is reflected on its mirror, which enables the client 150 that refers to the mirror to refer to the updated data.

What is claimed is:

1. A computer system, comprising:
one or more client computers; and
a storage system coupled to the client computers via a network,
wherein the storage system has a plurality of servers including a first server and a second server, and one or more disk subsystems coupled to the plurality of servers,
wherein the disk subsystems each have one or more logical devices for storing data written by the client computers,
wherein the servers each have an interface coupled to the network, a processor coupled to the interface, and a memory coupled to the processor,
wherein the first server manages, as one or more file systems, data stored in the logical devices,
wherein the second server manages a second directory tree, which is a replica of a first directory tree corresponding to an entirety or a part of one file system managed by the first server,
wherein the processor receives, from one of the client computers, via the interface, a request to access a file belonging to the first directory tree or the second directory tree, and judges whether the client computer that has issued the access request has a possibility of issuing at least one of update requests or not,
wherein, the processor selects the first directory tree, when judging that the client computer has a possibility of issuing at least one of update requests,
wherein, the processor selects the second directory tree, when judging that the client computer does not have a possibility of issuing at least one of update requests, and
wherein the processor executes access to the selected directory tree as requested, in a case where the selected directory tree is managed by a server to which the processor that has made the selection belongs.

2. The computer system according to claim 1,
wherein the processor judges that the client computer has a possibility of issuing at least one of update requests, in a case where the received access request is an update request, and
wherein the processor judges that the client computer does not have a possibility of issuing at least one of update requests, in a case where the received access request is not an update request.

3. The computer system according to claim 1,
wherein the servers each hold parameters set by the client computers,
wherein the processor refers to the parameter set by the client computer that has issued the received access request,
wherein the processor judges that the client computer has a possibility of issuing at least one of update requests, when the referred parameter has a value indicating that the client computer that has set this parameter has a possibility of issuing at least one of update requests, and
wherein the processor judges that the client computer does not have a possibility of issuing at least one of update requests, when the referred parameter has a value indicating that the client computer that has set this parameter does not have a possibility of issuing at least one of update requests.

4. The computer system according to claim 1,
wherein the servers hold information for identifying a client computer that has a possibility of issuing at least one of update requests, or information for identifying a client computer that does not have a possibility of issuing at least one of update requests, and
wherein the processor refers to the held information to judge whether the client computer that has issued the access request has a possibility of issuing at least one of update requests or not.

5. The computer system according to claim 1,
wherein the processor refers to, when receiving the access request, a path used by the client computer that has issued the access request and judges whether or not the path is one to be employed in issuing an update request,
wherein the processor judges that the client computer has a possibility of issuing at least one of update requests, in a case where the used path is one to be employed in issuing an update request, and
wherein the processor judges that the client computer does not have a possibility of issuing at least one of update requests, in a case where the used path is not one to be employed in issuing an update request.

6. The computer system according to claim 1, wherein, when the selected directory tree is not managed by the server to which the processor that has made the selection belongs, the processor sends, via the interface, information for identifying a server that manages the selected directory tree to the client computer that has issued the access request.

7. A storage system coupled to one or more client computers via a network, comprising:
a plurality of servers including a first server and a second server, and one or more disk subsystems coupled to the plurality of servers,
wherein the disk subsystems each have one or more logical devices for storing data written by the client computers,
wherein the servers each have an interface coupled to the network, a processor coupled to the interface, and a memory coupled to the processor,
wherein the first server manages, as one or more file systems, data stored in the logical devices,
wherein the second server manages a second directory tree, which is a replica of a first directory tree corresponding to an entirety or a part of one file system managed by the first server,
wherein the processor receives, from one of the client computers, via the interface, a request to access a file belonging to the first directory tree or the second directory tree, and judges whether the client computer that has issued the access request has a possibility of issuing at least one of update requests or not,
wherein the processor selects the first directory tree, when judging that the client computer has a possibility of issuing at least one of update requests,
wherein the processor selects the second directory tree, when judging that the client computer does not have a possibility of issuing at least one of update requests, and
wherein, the processor executes access to the selected directory tree as requested, in a case where the selected directory tree is managed by a server to which the processor that has made the selection belongs.

8. The storage system according to claim 7,
wherein the processor judges that the client computer has a possibility of issuing at least one of update requests, in a case where the received access request is an update request, and
wherein the processor judges that the client computer does not have a possibility of issuing at least one of update requests, in a case where the received access request is not an update request.

9. The storage system according to claim 7,
wherein the servers each hold parameters set by the client computers,
wherein the processor refers to the parameter set by the client computer that has issued the received access request,
wherein the processor judges that the client computer has a possibility of issuing at least one of update requests, when the referred parameter has a value indicating that the client computer that has set this parameter has a possibility of issuing at least one of update requests, and
wherein the processor judges that the client computer does not have a possibility of issuing at least one of update requests, when the referred parameter has a value indicating that the client computer that has set this parameter does not have a possibility of issuing at least one of update requests.

10. The storage system according to claim 7,
wherein the servers hold information for identifying a client computer that has a possibility of issuing at least one of update requests, or information for identifying a client computer that does not have a possibility of issuing at least one of update requests, and
wherein the processor refers to the held information to judge whether the client computer that has issued the access request has a possibility of issuing at least one of update requests or not.

11. The storage system according to claim 7,
wherein the processor refers to, when receiving the access request, a path used by the client computer that has issued the access request and judges whether or not the path is one to be employed in issuing an update request,
wherein the processor judges that the client computer has a possibility of issuing at least one of update requests, in a case where the used path is one to be employed in issuing an update request, and
wherein the processor judges that the client computer does not have a possibility of issuing at least one of update requests, in a case where the used path is not one to be employed in issuing an update request.

12. The storage system according to claim 7, wherein, when the selected directory tree is not managed by the server to which the processor that has made the selection belongs, the processor sends, via the interface, information for identifying a server that manages the selected directory tree to the client computer that has issued the access request.

13. A method of controlling a computer system, the computer system comprising:
one or more client computers; and
a storage system coupled to the client computers via a network,
wherein the storage system has a plurality of servers including a first server and a second server, and one or more disk subsystems coupled to the plurality of servers,
wherein the disk subsystems each have one or more logical devices to store data written by the client computers,
wherein the servers each have an interface coupled to the network, a processor coupled to the interface, and a memory coupled to the processor,
wherein the first server manages, as one or more file systems, data stored in the logical devices,
wherein the second server manages a second directory tree, which is a replica of a first directory tree corresponding to an entirety or a part of one file system that is managed by the first server, the method comprising:
receiving, by the processor, from one of the client computers, via the interface, a request to access a file belonging to the first directory tree or the second directory tree, and judging, by the processor, whether the client computer that has issued the access request has a possibility of issuing at least one of update requests or not;
selecting, by the processor, the first directory tree, when judging that the client computer has a possibility of issuing at least one of update requests;
selecting, by the processor, the second directory tree, when judging that the client computer does not have a possibility of issuing at least one of update requests; and
executing, by the processor, access to the selected directory tree as requested, in a case where the selected directory tree is managed by a server to which the processor that has made the selection belongs.

14. The method according to claim 13, further comprising:
judging, by the processor, that the client computer has a possibility of issuing at least one of update requests, in a case where the received access request is an update request; and
judging, by the processor, that the client computer does not have a possibility of issuing at lease one of update requests, in a case where the received access request is not an update request.

15. The method according to claim 13,
wherein the servers each hold parameters set by the client computers,
the method further comprising:
referring, by the processor, to the parameter set by the client computer that has issued the received access request;
judging, by the processor, that the client computer has a possibility of issuing at least one of update requests, when the referred parameter has a value indicating that the client computer that has set this parameter has a possibility of issuing at least one of update requests; and
judging, by the processor, that the client computer does not have a possibility of issuing at least one of update requests, when the referred parameter has a value indicating that the client computer that has set this parameter does not have a possibility of issuing at least one of update requests.

16. The method according to claim 13,
wherein the servers hold information for identifying a client computer that has a possibility of issuing at least one of update requests, or information for identifying a client computer that does not have a possibility of issuing at least one of update requests,
the method further comprising:
referring, by the processor, to the held information, and judging, by the processor, whether the client computer that has issued the access request has a possibility of issuing at least one of update requests or not.

17. The method according to claim 13, further comprising:
referring, by the processor, when receiving the access request, to a path used by the client computer that has issued the access request and judging, by the processor, whether or not the path is one to be employed in issuing an update request;
judging, by the processor, that the client computer has a possibility of issuing at least one of update requests, in a case where the used path is one to be employed in issuing an update request; and
judging, by the processor, that the client computer does not have a possibility of issuing at least one of update requests, in a case where the used path is not one to be employed in issuing an update request.

18. The method according to claim 13, further comprising, when the selected directory tree is not managed by the server to which the processor that has made the selection belongs, sending, by the processor, via the interface, information for identifying a server that manages the selected directory tree to the client computer that has issued the access request.
